(19) United States
(12) Patent Application Publication
(10) Pub. No.: US 2020/0241296 A1
(43) Pub. Date: Jul. 30, 2020

(54) Synchronized Shared Mixed Reality for Co-Located Participants, Apparatus, System and Method

(71) Applicant: Kenneth Perlin, New York, NY (US)

(72) Inventor: Kenneth Perlin, New York, NY (US)

(73) Assignee: New York University, New York, NY (US)

(21) Appl. No.: 16/773,782

(22) Filed: Jan. 27, 2020

Related U.S. Application Data
(60) Provisional application No. 62/798,203, filed on Jan. 29, 2019.

(51) Int. Cl. G02B 27/01; G06T 19/00; H04W 4/021

(52) U.S. Cl. CPC G02B 27/017; G02B 27/0179; G02B 2027/0187; H04W 4/021; G06T 2219/024; G06T 19/006

(57) ABSTRACT

A mixed reality headset for a participant of a synchronized shared mixed reality for co-located participants. A system for a synchronized shared mixed reality for co-located participants of an audience in an auditorium. The system includes a plurality of mixed reality headsets. Each headset has a display screen on which a display image is displayed in synchronization with all display screens of the plurality of headsets, and a sensor which receives a location signal to determine a position and orientation of the participant which is used to generate the display image is displayed and a receiver. The system includes a synchronizer which produces the synchronization signal that is received by the receiver of each headset. The system includes a locator which produces the location signal for the sensor which is received by the sensor, wherein the participants in the auditorium all experience a same shared immersive computer animated and spatial audio cinematic content, with each participant seeing and hearing the experience from each participants own unique perspective in the auditorium, as though the shared content by the participants were physically present in the auditorium itself. A method for a synchronized shared mixed reality for co-located participants of an audience in an auditorium.

### CROSS-REFERENCE TO RELATED APPLICATIONS

This is a nonprovisional of U.S. provisional application Ser. No. 62/798,203 filed Jan. 29, 2019, incorporated by reference herein.

### FIELD OF THE INVENTION

The present invention relates to viewing by co-located participants a mixed reality. (As used herein, references to the “present invention” or “invention” relate to exemplary embodiments and not necessarily to every embodiment encompassed by the appended claims.) More specifically, the present invention relates to viewing by co-located participants a mixed reality with each participant seeing and hearing the experience from each participant's own unique perspective in the location, as though the shared content by the participants were physically present in the auditorium itself using a laser projected IR pattern.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

There is related prior work to the present invention, but they are all different in one way or another. NaturalPoint (and then later Oculus) uses a single IR camera fixed in the scene to track a set of IR lights attached to the user's headset. Vive uses two rotating laser line patterns at a fixed point in the room, from which multiple headsets could track their own position and orientation by containing spatially arranged multiple IR sensors that intercepted those rotating lines at different times. Vuforia uses a visible image from which multiple users can track their own position and orientation with a camera pointed at that image. All use sensor fusion with an IMU.

### BRIEF SUMMARY OF THE INVENTION

The arrangement herein described supports the illusion among participating individuals at the same location, such as members of an audience within an auditorium, that they are all experiencing the same shared immersive computer animated and spatial audio cinematic content, with each participant seeing and hearing the experience from his or her own unique perspective in the auditorium, as though the shared content were physically present in the auditorium itself. The content can also optionally be mixed with a live performance by human performers and/or puppeteers to create a hybrid between a computer animated+spatial audio experience and a performance by live performers.

The present invention pertains to a mixed reality headset for a participant of a synchronized shared mixed reality for co-located participants. The headset includes a housing adapted to be disposed on a head of a user. The headset comprises a display screen attached to the housing on which a display image is displayed. The headset comprises a privacy filter disposed in front of the screen so only the display image on the display can be viewed by the participant and no other display images on any other display screen of other disciplines can be viewed. The headset comprises a receiver mounted to the housing which receives a synchronization signal to synchronize the display image on the display with other display images on other display screens of other participants. The headset comprises a mirror mounted to the housing which focuses the display image on the display screen onto an eye of the participant. The headset comprises an infrared camera mounted on the housing. The headset comprises a microprocessor having an internal IMU mounted to the housing which processes a location image captured by the camera to determine a position and orientation of the participant which is used to generate the display image on the display.

The present invention pertains to a system for a synchronized shared mixed reality for co-located participants of an audience in an auditorium. The system comprises a plurality of mixed reality headsets. Each headset has a display screen on which a display image that is displayed in synchronization with all display screens of the plurality of headsets, and a sensor which receives a location signal to determine a position and orientation of the participant which is used to generate the display image is displayed and a receiver. The system comprises a synchronizer which produces the synchronization signal that is received by the receiver of each headset. The system comprises a locator which produces the location signal for the sensor which is received by the sensor, wherein the participants in the auditorium all experience a same shared immersive computer animated and spatial audio cinematic content, with each participant seeing and hearing the experience from each participants own unique perspective in the auditorium, as though the shared content by the participants were physically present in the auditorium itself.

A method for a synchronized shared mixed reality for co-located participants of an audience in an auditorium. The method comprises the steps of displaying a display image on a display screen of each of a plurality of mixed reality headsets in synchronization with all display screens of the plurality of headsets. There is the step of receiving with a sensor a location signal to determine a position and orientation of the participant which is used to generate the display image that is displayed and a receiver. There is the step of producing with a synchronizer a synchronization signal that is received by a receiver of each headset to synchronize the display image displayed on each of the plurality of headsets. There is the step of producing with a locator the location signal for the sensor which is received by the sensor, wherein the participants in the auditorium all experience a same shared immersive computer animated and spatial audio cinematic content, with each participant seeing and hearing the experience from each participants own unique perspective in the auditorium, as though the shared content by the participants were physically present in the auditorium itself.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 shows a headset of the present invention on the head of a participant.

FIG. 2 is a block diagram regarding the headset.

FIG. 3 is a block diagram regarding a projector of the present invention.

FIG. 4 shows a pattern.

FIG. 5 shows another pattern.

FIG. 6 shows a module as it is plugged into the headset.

FIG. 7 shows non-raked audience.

FIG. 8 shows a raked audience.

FIG. 9 shows an alternative embodiment of the headset.

### DETAILED DESCRIPTION OF THE INVENTION

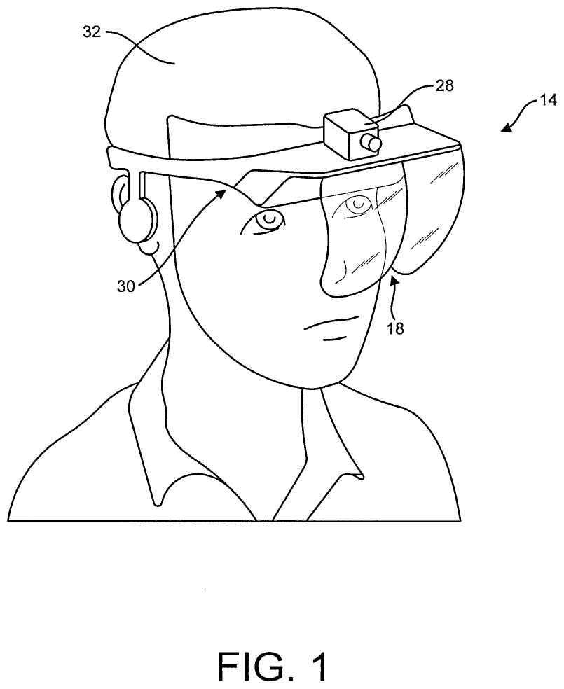

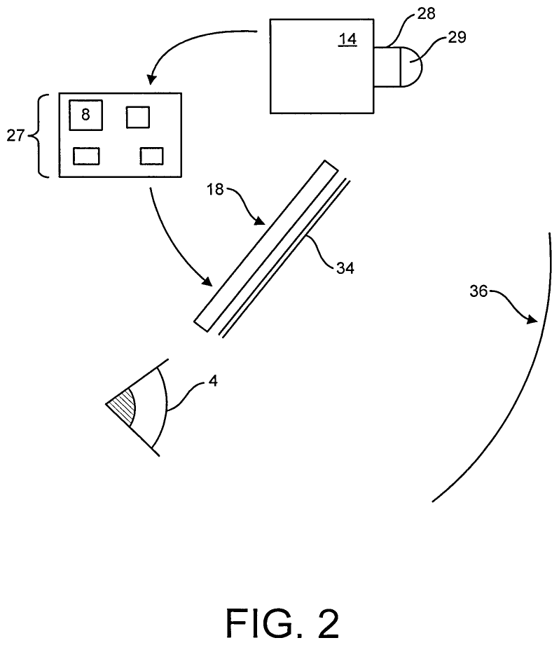

Referring now to the drawings wherein like reference numerals refer to similar or identical parts throughout the several views, and more specifically to FIGS. 1 and 2 thereof, there is shown a mixed reality headset 14 for a participant of a synchronized shared mixed reality for co-located participants 111. The headset 14 comprises a housing 30 adapted to be disposed on a head 32 of a user. The headset 14 comprises a display screen 18 attached to the housing 30 on which a display image 20 is displayed. The headset 14 comprises a privacy filter 34 disposed in front of the screen 18 so only the display image 20 on the display can be viewed by the participant and no other display images on any other display screen 18 of other disciplines can be viewed. The headset 14 comprises a receiver 24 mounted to the housing 30 which receives a synchronization signal to synchronize the display image 20 on the display with other display images on other display screens of other participants 111. The headset 14 comprises a mirror 36 mounted to the housing 30 which focuses the display image 20 on the display screen 18 onto an eye of the participant. The headset 14 comprises an infrared camera 28 mounted on the housing 30. The headset 14 comprises a microprocessor 27 having an internal IMU 8 mounted to the housing 30 which processes a location image 20 captured by the camera 28 to determine a position and orientation of the participant which is used to generate the display image 20 on the display.

The present invention pertains to a system 10 for a synchronized shared mixed reality for co-located participants 111 of an audience 56 in a location such as an auditorium 12, as shown in FIGS. 1-4, 7 and 8. The system 10 comprises a plurality of mixed reality headsets. Each headset 14 has a display screen 18 on which a display image 20 is displayed in synchronization with all display screens of the plurality of headsets, and a sensor 22 which receives a location signal to determine a position and orientation of the participant which is used to generate the display image 20 is displayed and a receiver 24. The system 10 comprises a synchronizer which produces the synchronization signal that is received by the receiver 24 of each headset 14. The system 10 comprises a locator 26 which produces the location signal for the sensor 22 which is received by the sensor 22, wherein the participants 111 in the auditorium 12 all experience a same shared immersive computer animated and spatial audio cinematic content, with each participant seeing and hearing the experience from each participant's 111 own unique perspective in the auditorium 12, as though the shared content by the participants 111 were physically present in the auditorium 12 itself.

The sensor 22 may include a near infrared camera 28 mounted on each headset 14. The locator 26 may include an infrared laser 38. The locator 26 may include a pattern 39 generator 40 mounted on the infrared laser 38 which produces infrared tracking data from light from the infrared laser 38 passing through the pattern 39 generator 40. The system 10 may include a diffuse projection surface 42 upon which the infrared tracking data is projected by the infrared laser 38.

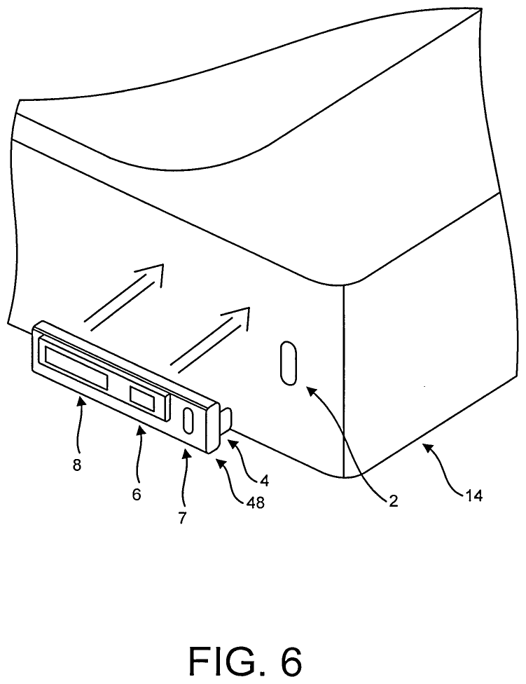

The synchronizer may include one or more infrared LEDs 44. The synchronizer may include a timer 46 to modulate the LEDs 44 to provide a periodic flashing synchronization signal. The system 10 may include an infrared module 48 with a photodiode 50 that plugs into a headset 14 dataport 52, as shown in FIG. 6. The system 10 may include a computer processor associated with each headset 14 which performs a sensor 22 fusion computation from the infrared tracking data captured by the infrared camera 28 and an IMU 8. The computer processor may use the infrared tracking data captured by the infrared camera 28 and the IMU 8 to generate the display image 20 on the display screen 18 of each headset 14 as well as correct spatial audio so that the co-located participants 111 both see and hear the display image 20 from the co-located participants' position and orientation in the auditorium 12. The computer microprocessor 27 may produce a silhouette in the display image 20 of a co-located participant.

A method for a synchronized shared mixed reality for co-located participants 111 of an audience 56 in an auditorium 12. The method comprises the steps of displaying a display image 20 on a display screen 18 of each of a plurality of mixed reality headsets in synchronization with all display screens of the plurality of headsets. There is the step of receiving with a sensor 22 a location signal to determine a position and orientation of the participant which is used to generate the display image 20 that is displayed and a receiver 24. There is the step of producing with a synchronizer a synchronization signal that is received by a receiver 24 of each headset 14 to synchronize the display image 20 displayed on each of the plurality of headsets. There is the step of producing with a locator 26 the location signal for the sensor 22 which is received by the sensor 22, wherein the participants 111 in the auditorium 12 all experience a same shared immersive computer animated and spatial audio cinematic content, with each participant seeing and hearing the experience from each participant's 111 own unique perspective in the auditorium 12, as though the shared content by the participants 111 were physically present in the auditorium 12 itself.

INVENTORY OF PHYSICAL COMPONENTS
1. An audience 56 of participants 111
2. One mixed reality headset 14 per participant
3. A display screen 18 contained within the headset 14
4. View-angle restricting privacy filters in front of the headset 14 display screen 18
5. An optical system contained within the headset 14
6. A pair of audio headphones contained within the headset 14
7. A computer processor associated with the headset 14
8. An IMU 8 contained within the headset 14
9. A near infrared (IR) camera 28 mounted on each headset 14
10. A wide-angle lens 29 attached to the headset 14 IR camera 28
11. A known “eye window” for the location of each of the user's eyes wrt the headset 14
12. A thin plate that is transparent to visible light while being reflective to IR light
13. An IR laser 38
14. A possible location for the laser 38 behind the audience 56
15. Another possible location in front of the audience 56
16. A pattern 39 generator 40 mounted on the IR laser 38
17. A diffuse projection surface 42 upon which the IR tracking data is projected
18. A fixed IR pattern 39 that the laser 38 projects onto the diffuse projection surface 42
19. One or more IR LEDs 44
20. A timer 46 to modulate the LEDs 44 to provide a periodic flashing synchronization signal
21. An electric power source for the laser 38, LEDs 44 and timer 46
22. IR module 48 with photodiode 50 that plugs into a headset 14 data port

A mixed reality headset 14, as shown in FIG. 1, can be used for each audience 56 member, such as this optical see-through mixed reality device that uses a commercially available optical configuration:

The components of the headset 14 relevant to the method of position tracking are as follows:

The display screen 18 can be overlaid with a privacy filter 34 which is placed over the screen 18, so that participants 111 do not see the screen 18 image 20 generated for each other's' displays, as shown in FIG. 2. This privacy filter 34 can consist of a microlouvered layer, as is standard in the art. It can also consist of two such layers, one to prevent off axis viewing horizontally, and the other to prevent off axis viewing vertically. Each of the left/right displayed images on the display screen 18 is focused by a transparent curved mirror 36 onto the corresponding eye of the participant. An infrared camera 28 mounted on the headset 14 is outfitted with a wide-angle lens 29. The image 20 captured by the camera 28 is processed by a microprocessor 27 containing an internal IMU 8, mounted on the headset 14.

Step by Step Operation by User

Users sit down in their seats in the auditorium 12, and each user puts on a headset 14. All users then see and hear pre-recorded content with the sensory illusion that said content is being performed live by actors who are physically present in the room, such as would be the case for a live performance by actors on a stage.

Step by Step Internal Operation

Tracking the position and orientation of each headset 14

To perform inside out tracking, an IMU 8 (which can be the IMU 8 of the processor of a SmartPhone), and a forward-facing IR camera 28 are both contained within the headset 14.

The computer processor associated with this headset 14 does a sensor fusion computation from the IR pattern 39 captured by the camera 28 and the IMU 8 to compute the position and orientation of the participant, and this information is used to generate the proper image 20 on the display, as well as correct spatial audio, so that the participant both sees and hears the virtual scene from his/her correct position and orientation in the physical room.

The computer processor can be physically contained within the headset 14, but does not need to be. In one embodiment the processor is contained within a SmartPhone attachable to the headset 14 which also contains the display screen 18 and can contain the IMU 8. In another embodiment the computer processor is attached to the headset 14 via a wire that can provide both power and data connection with the headset 14. In the latter case, the headset 14 can be much lighter in weight, since it does not need to have either a computer processor nor an on-board battery—only a small microprocessor 27 sufficient to manage data transfer to and from the headset's display, camera 28 module 48 and IMU 8.

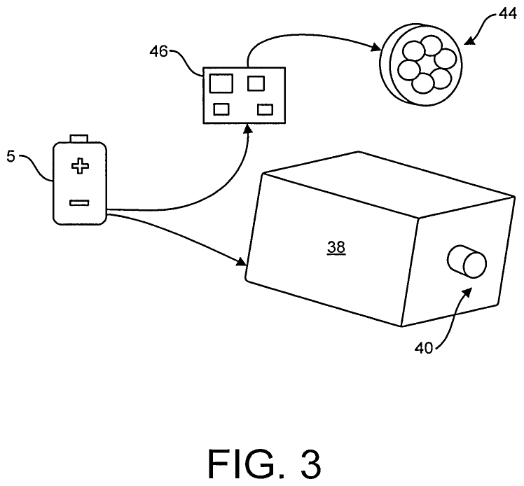

A projector, as shown in FIG. 3, is placed in a fixed location within the auditorium 12, comprising an IR laser 38, which can in one embodiment emit at wavelength 808nm, to which is attached a pattern 39 generator 40, as well as a cluster of IR LEDs 44 controlled by a timer 46. The laser 38 and the time-modulated LED cluster are powered by an electrical power source 5.

These components are used to project a fixed IR target pattern 39 onto a surface of the auditorium 12, which in one embodiment can be the front wall. Each participant's camera 28 has a unique wide-angle view of this target pattern 39, which will vary depending upon that user's head 32 position and orientation. The reason for using a wide-angle camera 28 is that the pattern 39 which is projected onto one surface of the auditorium 12 will then continue to be visible to the camera 28 even when the user turns his/her head 32 toward various directions. Because a wide-angle lens 29 is used, a software undistortion filter 34 is applied to the captured video image 20, to undo the image 20 distortion caused by the wide-angle lens 29.

Therefore, there is no need to mount a fixed visible image 20 in the room as in the case of Vuforia. A laser 38 generated IR pattern 39 is (1) not visible to users, and (2) much easier to track than a visible image 20 because it appears extremely bright to the IR camera 28 compared with everything else in the room, and therefore a very simple tracking pattern 39 can be used which therefore can be very robust for tracking and require very little computation.

For each participant's headset 14, the positions within that headset's camera 28 image 20 of a collection of key tracking points in the projected pattern 39 are combined on the computer processor associated with that headset 14 via sensor fusion with the headset's IMU 8, to compute the position and orientation of the computer graphic imagery that the participant will see. This can be done using standard techniques of sensor fusion.

The projected target pattern 39 can consist of a set of lines that intersect at known locations, such as the following pattern 39. In this image 20, the thick black lines represent areas where IR light is projected and the thin black lines represent an optional extent for the diffuse projection material.

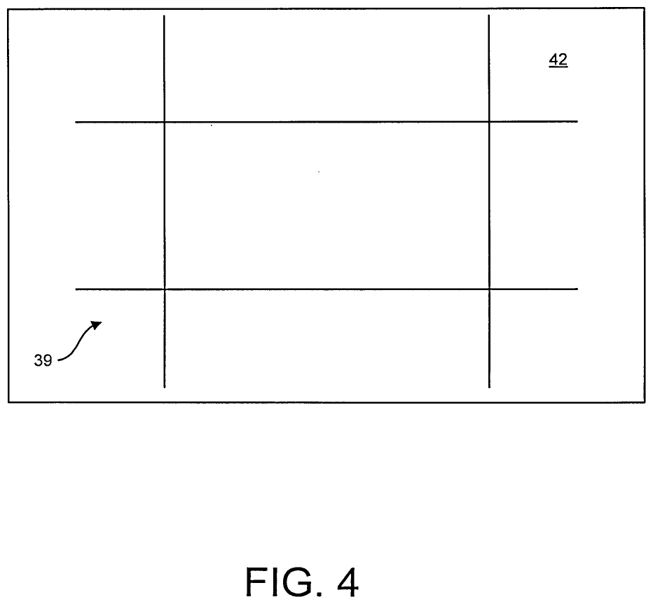

In the example of the pattern 39 shown in FIG. 4, simple and robust methods that are well known in the field can be employed to extract the 3D position and orientation of a camera 28, given the projected positions onto the captured image 20 of at least four points in space whose actual positions are known (in this case, the four corners of a rectangle), assuming that the camera's focal length and lens 29 distortion function are also known.

The room is kept visibly dark, so that there is little or no perceptible visible light on the front or side walls or ceiling of the auditorium 12 that could interfere with the augmented reality computer graphic overlay for each participant.

The key differentiator between this technique and previous techniques that have also used camera 28 based tracking of headsets and then incorporated sensor fusion using an IMU 8 is that in the case of the current invention, an arbitrarily large number of headsets (each with its own IMU 8) are being tracked simultaneously, while all of the respective headset 14 cameras are looking toward the same IR pattern 39.

Using the current invention, there is no practical upper limit on the number of headsets that can be simultaneously tracked in this manner, and therefore there is no practical upper limit on the number of physically co-located mixed reality users who can be supported using this tracking technique to create the visual illusion for every user that are users all inhabiting the same computer-generated virtual space which is mapped onto their shared physical space in a way that is consistent across all users.

Implementing Temporal Synchronization

Each participant sees and hears the same immersive cinematic content, as though that content was being perceived from that participant's unique location in the room. A synchronization signal is periodically transmitted to the phone of each participant's headset 14, in order to ensure that all participants 111 are seeing and hearing the same content at the same time. In an earlier disclosure, we described an enablement in which this signal is transmitted to each headset 14 via Wi-Fi.

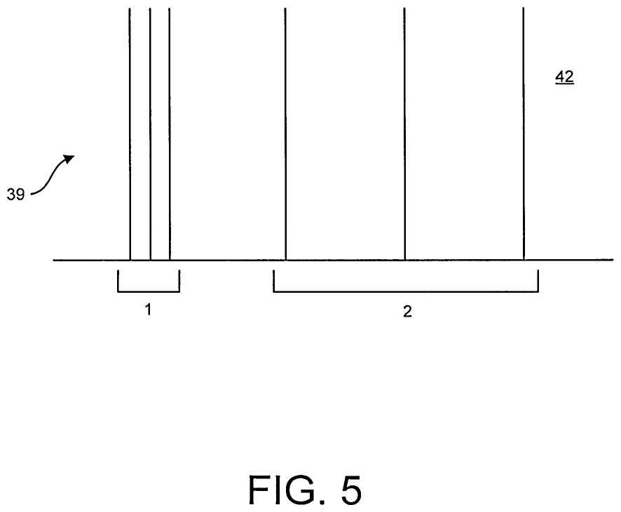

Another method of temporal synchronization, in which the target screen 18 is periodically flooded with IR light in short bursts by an IR Light Emitting Diode (LED) 44 or alternatively, a cluster of such LEDs 44, can be co-located with the pattern-emitting IR laser 38. During video capture frames for which such a burst is present, the target will appear to each headset's camera 28 as a bright rectangle. Various temporal patterns of such bursts can be used to trigger different software events. For example, as shown in FIG. 5, three bursts in a row at successive intervals of 500 msec (1) can signal all headsets to simultaneously begin showing the same previously recorded cinematic content. A sequence of periodic bursts at regular time intervals, where the duration of each interval can be three seconds in one embodiment (2), can then subsequently be used to maintain synchronization of this content, despite any variation in the rates of the computer clocks in each of the headsets. This optically based method of synchronization has the advantage that it does not require the use of Wi-Fi or wired digital network.

This method of temporal synchronization can also be adopted to VR headsets that have a video pass-through capability, such as the Oculus Quest. In this case, a small module 48 is plugged into the data port of the headset 14 (which in the case of the Oculus Quest is a USB type-C port). This module 48 contains an IR sensitive photodiode 50 and a small microprocessor 27. In response to the bursts from the LED 44, the photodiode 50 acts as a closed switch. The microprocessor 27 detects this change, and sends a corresponding digital alert to the software running on the headset's computer processor, which then implements the abovementioned synchronization and timing signal protocol.

Optionally, the module 48 can detect 980 nm wavelength IR that is modulated at a frequency currently employed for television remote control, such as 37 Khz. The LED 44 transmitter that transmits the timing synchronization light pulses would then also employ a modulation circuit of matching frequency and LEDs 44 of matching wavelength. The use of such modulation has the advantage that it allows the experience to operate even in the presence of significant levels of ambient IR light, such as at any venue where there are incandescent sources of illumination or where there is exposure to sunlight. The use of an industry standard modulation frequency has the advantage that inexpensive commodity versions of such detection circuits already exist.

Similarly, the carrier signal can be Radio Frequency (RF). In one embodiment, this is a modulated 315 MHz signal, modulated at 37 Khz to distinguish it from background radio signals. The advantage of RF over IR is that it operates at longer distances and it does not require line of sight between the transmitter and the receiver 24.

In addition, the transmission and reception can employ the industry standard format for communication by television remote control. In one embodiment, the seven bit binary signal “000 0000”, which corresponds to “Button 1” on a television remote control, can be used to start the experience, and the seven bit binary signal “000 0001”, which corresponds to “Button 2” on a television remote control, can be sent every three seconds to maintain temporal synchronization across all headsets.

In the case of headsets such as the Oculus Quest, which currently only allow keyboard or mouse as recognized devices on their USB-C data port, the module 48 can perform a software emulation of a keyboard. In this mode, an ascii value can be assigned to each command needed for temporal synchronization. In one embodiment, every pulse received from the RF transmitter is sent over the USB-C port as a SPACE key (ascii value=32), using the timing system already described to convert pulses into temporal synchronization signals. In other embodiments, different ascii codes can be sent over the USB-C port to provide any desired expanded capability. Because all of participants' headsets receive exactly the same signals at the same time, the result is that all headsets will be temporally synchronized with each other.

In FIG. 6, the headset 14 contains a USB-C port 2. The module 48 is designed to plug into this port 2 via a male USB-C connector 4 in such a way that the entire module 48 fits unobtrusively on the side of the headset 14. Inside, the module 48 contains a receiving submodule 8, which in one embodiment is a 315 Mhz RF receiver 24, and a logic submodule 6, which in one embodiment converts a received RF pulse into a software emulation of a SPACE key on an ascii keyboard device. As a convenience for the operator, the module can also optionally contain a pass-through USB-C port 7. This will allow the USB-C port 7 to be used for other functions, such as charging, without requiring the module 48 to be removed.

The photodiode 50 plugged into the headset 14 data port can be used to act essentially as the receiver 24 of a television remote, with all headsets receiving a sync signal from a single transmitter. When an infrared signal is sent to the room from a signal IR source (essentially exactly the same technology as is found in today's television remotes), that signal is received at the same time by all headsets, thereby allowing a time synchronization of all headset 14 participants 111, and thereby temporally synchronizing the experience for all participants 111.

The advantage of this approach is that it will work even when the shared system 10 is being operated without any shared internet connectivity (such as Wi-Fi), assuming that all content is locally stored on each headset 14, which will be the case for many use cases, such as each participant in the room watching the same immersive VR movie, with each participant watching from his/her own respective location in the room.

The sequence of internal operations in the embodiment is as follows:
1. The transmitter sends an RF pulse, to be received simultaneously by all headsets;
2. The RF receiver 24 submodule receives the pulse;
3. The logic submodule turns this signal into an emulation of a SPACE key press+release;
4. An application in the headset's processor uses this signal for temporal synchronization.

Since these headsets typically already perform self-contained inside-out room-scale position and orientation tracking, they will typically require the use of IR or RF only for temporal synchronization, and will not require the IR laser 38 position tracking subsystem.

As is the case for the aforementioned optical see-through embodiment, this optically based method of synchronization has the advantage that it does not require the use of Wi-Fi or wired digital network.

Physical Arrangement of the Audience 56

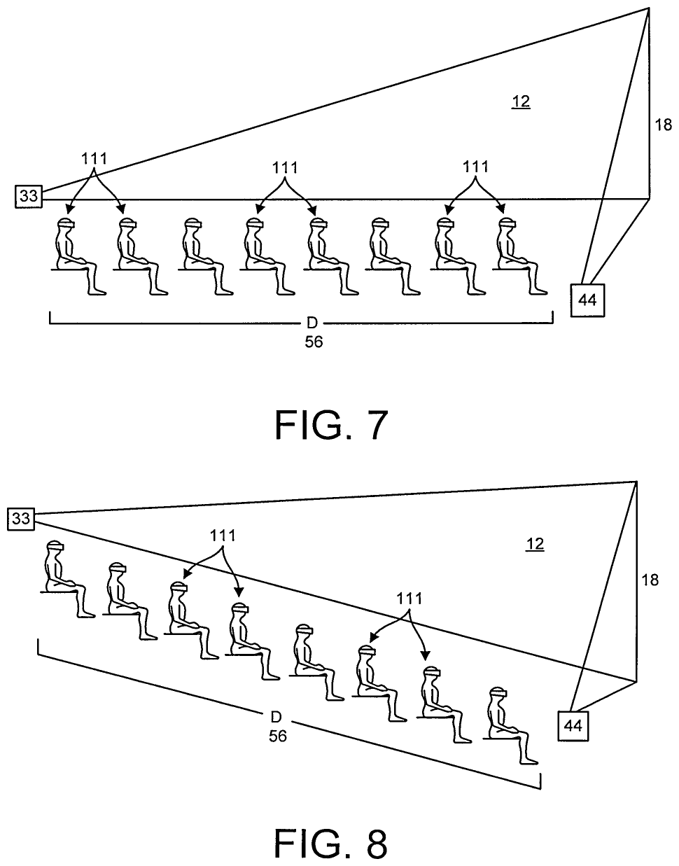

The theater can be either not raked or raked, as seen in FIGS. 7 and 8, in these two side. views, respectively. In either case, the audience 56 of co-located participants 111 in the auditorium 12 is facing a visibly dark screen 18 which is illuminated only by the IR target pattern 39, which emanates from a projector which can be located in many possible locations, including behind 33 the audience 56 or in front 44 of the audience 56.

Creating Audience 56 Silhouettes

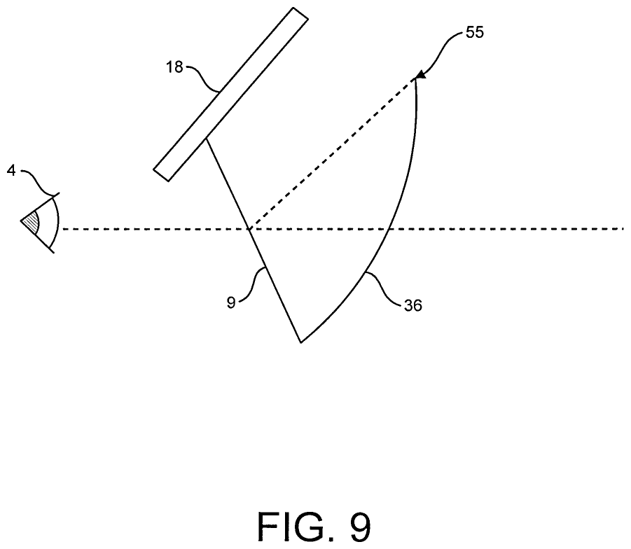

As described thus far, the invention is capable of placing computer graphic elements as transparent objects between audience 56 members, but is not capable of placing computer animated elements behind members of the audience 56, such that the silhouettes of the audience 56 members block out the graphical elements as would be the case in real physical surroundings (for example, if the audience 56 were located in a forest). In order to support such a silhouetting capability, the following variation upon the architecture of the headset 14 is described in regard to FIG. 9.

The headset 14 is altered such that a thin transparent plate 9 is placed between the display screen 18 and the transparent focusing mirror 36. The plate material is chosen such that it is transparent to visible light, while being reflective in near infrared. In one embodiment, the plate is a dichroic mirror 36. Rather than a single camera 28 facing forward, the headset 14 contains two cameras, one for each eye. Each camera 28 is positioned and oriented 55 to point toward the plate 9 so that its reflection is optically superimposed upon the corresponding eye 4 of the participant 111. Infrared light from the outside world will enter through each reflecting lens 29, then will be reflected upward from the corresponding plate toward the camera 28. The effect will be that the camera 28 will be optically superimposed upon the participant's eye window, and therefore that each camera 28 will see exactly what is seen by the corresponding eye of the participant.

Meanwhile, this arrangement will not interfere with the visible path of light from the display screen 18 to the focusing mirror 36 into the participant's eye 4, because the interposed plate is transparent to visible light.

The walls of the auditorium 12 are painted so as to be black in the visible spectrum, yet highly reflective in the near infrared, using a paint material that has such properties, such as is currently sold by Epolin Incorporated. The surfaces of the auditorium 12 are illuminated with IR light, to create a diffuse IR glow upon the walls. The IR camera 28 will therefore see the audience 56 as black, the tracking target pattern 39 as bright white, and the surfaces of the theater as gray.

The difference between the IR black of the audience 56 and the IR gray of the theater surfaces is used to create a matte image, which computer software can then employ to ensure that selected computer-generated imagery will appear only behind audience 56 members, by setting all regions of the computer-generated image 20 to black wherever the captured IR image is black (that is, where audience 56 members are visibly blocking the theater surfaces). In this way a compelling illusion can be maintained that a computer-generated scene is surrounding the audience 56. The audience 56 can also optionally be faintly lit by sources of ambient illumination in the visible spectrum, thereby allowing audience 56 members to see each other's facial expressions.

The computer software running on the computer associated with each headset 14 can also, with this method, create the illusion that selected computer-generated imagery is floating in the air in front of all other audience 56 members, simply by ignoring the matte image in its calculations.

The key difference between this part of the invention and the earlier described parts of this invention is that each outward facing IR camera 28 is now placed in the optical path in such a way that it appears to be coincident with the user's own view of the scene from the left and right eyes, respectively, rather than from a nearby but different location. This allows the IR image to be used in a way that mattes out audience 56 members and other objects in the physical world, so that they will appear properly to be in front of the virtual scene, as they would, for example, in the case of a live stage performance in the theater.

From the perspective of each user, the fact that the heads and bodies of other users can appear in front of the virtual content if desired, appearing to block that content from view, creates a vivid illusion that the virtual content is physically in the same room with the assembled users, as would be the case, for example, if the audience 56 were watching a live theater performance with real actors.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A system for a synchronized shared mixed reality for co-located participants of an audience in an auditorium comprising:
a plurality of mixed reality headsets, each of which has a display screen on which a display image is displayed in synchronization with all display screens of the plurality of headsets and a sensor which receives a location signal to determine a position and orientation of the participant which is used to generate the display image is displayed and a receiver;
a synchronizer which produces the synchronization signal that is received by the receiver of each headset; and
a locator which produces the location signal for the sensor which is received by the sensor, wherein the participants in the auditorium all experience a same shared immersive computer animated and spatial audio cinematic content, with each participant seeing and hearing the experience from each participants own unique perspective in the auditorium, as though the shared content by the participants were physically present in the auditorium itself.

2. The system of claim 1 wherein the sensor includes a near infrared camera mounted on each headset.

3. The system of claim 2 wherein the locator includes an infrared laser.

4. The system of claim 3 wherein the locator includes a pattern generator mounted on the infrared laser which produces infrared tracking data from light from the infrared laser passing through the pattern generator.

5. The system of claim 4 including a diffuse projection surface upon which the infrared tracking data is projected by the infrared laser.

6. The system of claim 5 wherein the synchronizer includes one or more infrared LEDs.

7. The system of claim 6 wherein the synchronizer includes a timer to modulate the LEDs to provide a periodic flashing synchronization signal.

8. The system of claim 7 including an infrared module with a photodiode that plugs into a headset dataport.

9. The system of claim 8 including a computer microprocessor associated with each headset which performs a sensor fusion computation from the infrared tracking data captured by the infrared camera and an IMU.

10. The system of claim 9 wherein the computer microprocessor uses the infrared tracking data captured by the infrared camera and the IMU to generate the display image on the display screen of each headset as well as correct spatial audio so that the co-located participants both see and hear the display image from the co-located participants' position and orientation in the auditorium.

11. The system of claim 10 wherein the computer microprocessor produces a silhouette in the display image of a co-located participant.

12. A mixed reality headset for a participant of a synchronized shared mixed reality for co-located participants comprising:
a housing adapted to be on a head of a user;
a display screen attached to the housing on which a display image is displayed;
a privacy filter disposed in front of the screen so only the display image on the display can be viewed by the participant and no other display images on any other display screen of other disciplines can be viewed;
a receiver mounted to the housing which receives a synchronization signal to synchronize the display image on the display with other display images on other display screens of other participants;
a mirror mounted to the housing which focuses the display image on the display screen onto an eye of the participant;
an infrared camera mounted on the housing; and
a microprocessor having an internal IMU mounted to the housing which processes a location image captured by the camera to determine a position and orientation of the participant which is used to generate the display image on the display.

13. A method for a synchronized shared mixed reality for co-located participants of an audience in an auditorium comprising the steps of:
displaying a display image on a display screen of each of a plurality of mixed reality headsets in synchronization with all display screens of the plurality of headsets;
receiving with a sensor a location signal to determine a position and orientation of the participant which is used to generate the display image that is displayed and a receiver;
producing with a synchronizer a synchronization signal that is received by a receiver of each headset to synchronize the display image displayed on each of the plurality of headsets; and
producing with a locator the location signal for the sensor which is received by the sensor, wherein the participants in the auditorium all experience a same shared immersive computer animated and spatial audio cinematic content, with each participant seeing and hearing the experience from each participants own unique perspective in the auditorium, as though the shared content by the participants were physically present in the auditorium itself.
